(19) United States
(12) Patent Application Publication
(10) Pub. No.: US 2006/0153164 A1
(43) Pub. Date: Jul. 13, 2006

(54) System and method for voice modulating in telephone

(75) Inventors: Chengshing Lai, Taipei (TW); Fitch Fan, Nanking City (CN); Ronglin Qin, Nanking City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/147,340

(22) Filed: Jun. 8, 2005

(30) Foreign Application Priority Data
Jan. 13, 2005 (TW) 094101052

(51) Int. Cl. H04L 12/66

(52) U.S. Cl. 370/352

(57) ABSTRACT

A telephone for voice modulating includes a receiver, a voice modulating unit, a communication unit, and a control unit. The receiver receives a voice signal. The voice modulating unit generates a modulated voice signal by modulating the voice signal. The communication unit outputs the voice signal or the modulated voice signal. In addition, a method for voice modulating applied on the telephone is provided.

### BACKGROUND OF THE INVENTION

1. Field of Invention

The invention relates to a telephone and a method and, in particular, to a telephone for voice modulating and a method for voice modulating applied in the telephone.

2. Related Art

In the conventional technologies, the voice modulating process is usually applied in the music edition field, the karaoke field, or the likes. Equipping with the voice modulating function, the consumer goods, such as the karaoke machines or toys, can achieve the preferred entertainment effects. In addition, using the convenient wireless telephone or bounded telephone to communicate with others is one of the most common behaviors of humans in the current information age. If the telephone can provide the voice modulating function, the identity of the speaker can be hidden and the telephone can provide a preferred entertainment effect.

It is therefore an important subject of the invention to provide a telephone, which can provide a voice modulating function, and a method for voice modulating applied in the telephone.

### SUMMARY OF THE INVENTION

In view of the foregoing, the invention is to provide a telephone, which can provide a voice modulating function, and a method for voice modulating applied in the telephone.

To achieve the above, a telephone for voice modulating of the invention comprises a receiver, a voice modulating unit, a communication unit, and a control unit. In the invention, the receiver receives a voice signal. The voice modulating unit generates a modulated voice signal by modulating the voice signal. The communication unit outputs the voice signal or the modulated voice signal. The control unit drives the voice modulating unit to generate the modulated voice signal and decides the modulated voice signal outputted by the communication unit.

Furthermore, the invention also discloses a method for voice modulating, which comprises the following steps of: receiving a voice signal, modulating the voice signal to generate a modulated voice signal, and outputting the voice signal or the modulated voice signal.

As mentioned above, the telephone for voice modulating provides a voice modulating unit for generating a modulated voice signal. The modulated voice signal is then transmitted to another telephone. Thus, the user of the another telephone may not distinguish the identity of the speaker with the modulated voice. Accordingly, the telephone for voice modulating of the invention can provide some entertainment so as to improve the competitiveness thereof.

### BRIEF DESCRIPTION OF THE DRAWINGS

The invention will become more fully understood from the detailed description given herein below illustration only, and thus is not limitative of the present invention, and wherein:

FIG. 1 is a block diagram showing a telephone for voice modulating according to a preferred embodiment of the invention;

FIG. 2 is another block diagram showing a telephone for voice modulating according to the preferred embodiment of the invention; and

FIG. 3 is a flowchart of a method for voice modulating according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

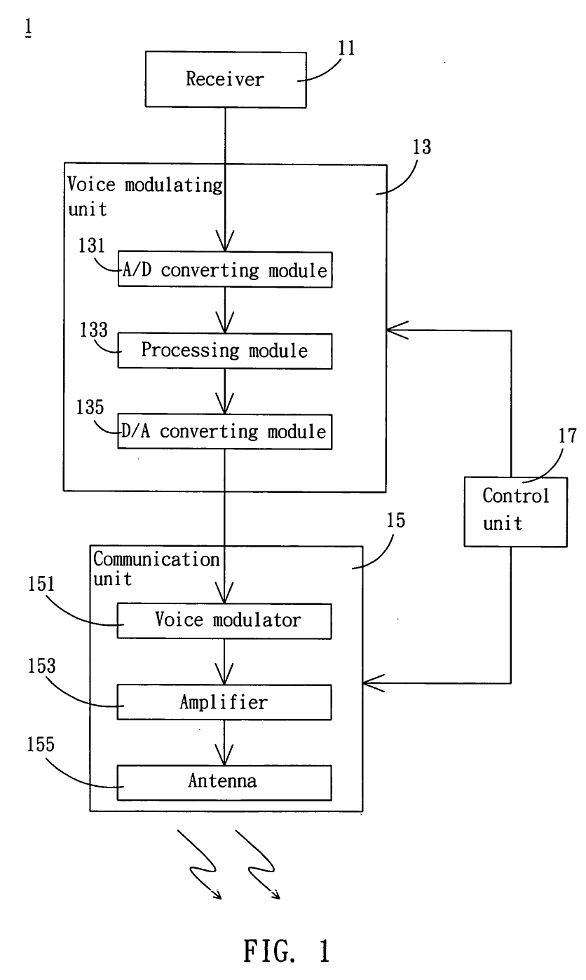

With reference to FIG. 1, a telephone 1 for voice modulating according to a preferred embodiment of the invention is disclosed. In this embodiment, the telephone 1 is a mobile phone, which is applied in the GSM 900 system, GSM 1800 system, GPRS system, or other systems that are known by those skilled persons. The telephone 1 can provide a voice modulating function for the speaker for generating a modulated voice signal. Then, if the user uses the telephone 1 to make a phone call with another telephone, such as a mobile phone or a bounded telephone, the user of the another telephone may not distinguish the identity of the speaker. Accordingly, the telephone 1 can provide some entertainment effects.

In the present embodiment, the telephone 1 includes a receiver 11, a voice modulating unit 13, a communication unit 15, and a control unit 17. Herein, the receivrt 11 is a microphone of a mobile phone. When the speaker uses the telephone 1 to make a phone call, the receiver 11 is to receive the voice signal from the speaker.

The voice modulating unit 13 connects the receiver 11 for receiving the voice signal, and generates a modulated voice signal by modulating the voice signal. After that, the voice modulating unit 13 transmits the modulated voice signal to the communication unit 15. In this embodiment, the voice modulating unit 13 includes an A/D converting module 131, a processing module 133 and a D/A converting module 135.

The A/D converting module 131 connects the receiver 11 for receiving the voice signal and converts the voice signal into a digital voice signal for the following processes. In the converting process, the A/D converting module 131 executes a sampling process with the voice signal. Then, the A/D converting module 131 executes a quantization process with the sampled voice signal, and modulates the quantized voice signal into a digital voice signal according an encoding process.

The processing module 133 performs an operation of the digital voice signal to generate a digital modulated voice signal corresponding to the digital voice signal. In the current embodiment, the processing module 133 firstly performs a Fourier Transform of the digital voice signal so as to transform the digital voice signal into a frequency signal of frequency domain. Next, the processing module 133 shifts the frequency signal so as to change the frequency of the digital voice signal. Then, the processing module 133 performs an inverse Fourier Transform of the frequency signal with changed frequency for generating a digital voice signal of time domain. Accordingly, the desired digital modulated voice signal can be obtained.

The D/A converting module 135 connects the processing module 133 for converting the digital modulated voice signal into an analog modulated voice signal, and then transmits the modulated voice signal to the communication unit 15.

In the present embodiment, the communication unit 15 is a wireless communication module, which includes a voice modulator 151, an amplifier 153, and an antenna 155. When the communication unit 15 receives the modulated voice signal from the voice modulating unit 13, the voice modulator 151 modulates the modulated voice signal into an RF signal. Then, the amplifier 153 amplifies the RF signal, and the amplified RF signal is transmitted to another telephone via the antenna 155. In this case, the voice signal received by the another telephone is the modulated voice signal.

The control unit 17 drives the voice modulating unit 13 to generate the modulated voice signal and deciding the modulated voice signal outputted by the communication unit 15. Accordingly, the telephone 1 of the invention can be equipped with the voice modulating function. For example, the telephone 1 can change the male voice to a female voice, or change the female voice to a male voice. Besides, the user can utilize the control unit 17 to control the transmitted voice signal. For example, by the control unit 17, one sentence of the modulated voice signal can be transmitted, and another sentence of the voice signal can then be transmitted immediately.

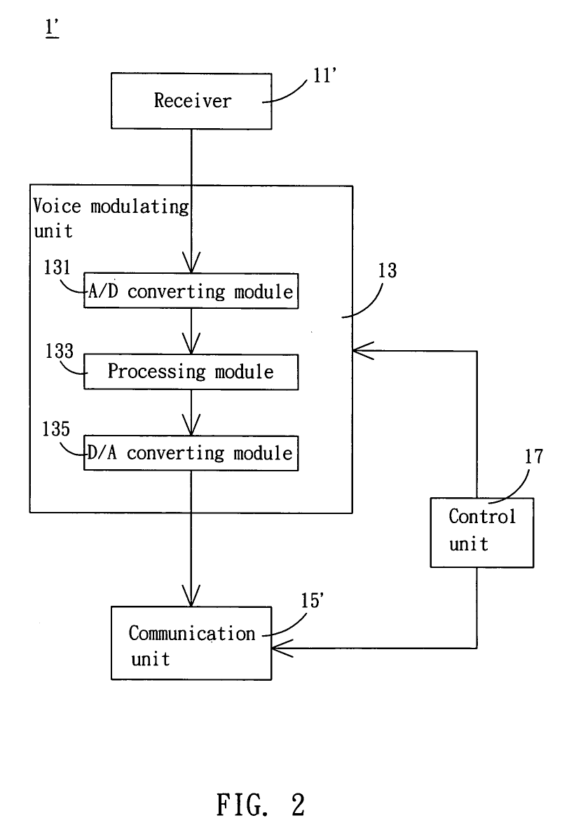

With reference to FIG. 2, a telephone 1′ for voice modulating according to the preferred embodiment of the invention is disclosed. In this embodiment, the telephone 1′ is a bounded telephone, wherein the same references relate to the same elements described in the previously mentioned embodiment.

In this embodiment, the telephone 1′ includes a receiver 11′, a voice modulating unit 13, a communication unit 15′, and a control unit 17. Herein, the receiver 11′ is a microphone of a bounded telephone. When the speaker uses the telephone 1′ to make a phone call, the receiver 11′ is to receive the voice signal from the speaker. The voice modulating unit 13 connects the receiver 11 for receiving the voice signal, and generates a modulated voice signal by modulating the voice signal. After that, the voice modulating unit 13 transmits the modulated voice signal to the communication unit 15′. In this embodiment, the communication unit 15′ is a wired communication module. The communication unit 15′ can communicate with another telephone through the telephone line and PSTN (Public Service Telephone Network) so as to change voice signals between the telephones. The control unit 17 drives the voice modulating unit 13 to generate the modulated voice signal and deciding the modulated voice signal outputted by the communication unit 15′. Herein, the another telephone can be a bounded telephone or a mobile phone.

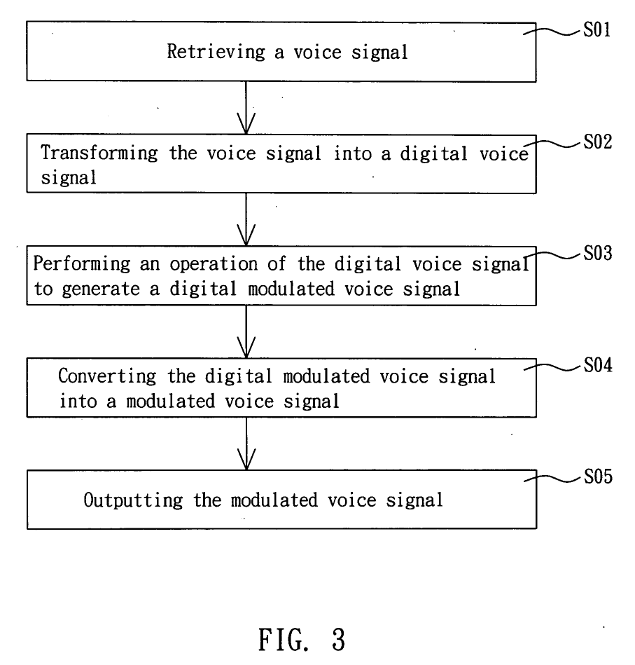

Referring to FIG. 3, a method for voice modulating according to the preferred embodiment of the invention is disclosed. The method for voice modulating can be applied with the above-mentioned telephone 1, and include the following steps.

In a step S01, a voice signal is retrieved. When the speaker uses the telephone 1 to make a phone call, the receiver 11 is to receive the voice signal from the speaker.

In a step S02, the voice signal is transformed into a digital voice signal. In this case, the A/D converting module 131 executes a sampling process with the voice signal, executes a quantization process with the sampled voice signal, and modulates the quantized voice signal into a digital voice signal according an encoding process.

In a step S03, the digital voice signal is modulated to generate a digital modulated voice signal. In this case, the processing module 133 firstly performs a Fourier Transform of the digital voice signal so as to transform the digital voice signal into a frequency signal of frequency domain. Next, the processing module 133 shifts the frequency signal so as to change the frequency of the digital voice signal. Then, the processing module 133 performs an inverse Fourier Transform of the frequency signal with changed frequency for generating a digital voice signal of time domain. Accordingly, the desired digital modulated voice signal can be obtained.

In a step S04, the digital modulated voice signal is transformed into a modulated signal. In this case, the D/A converting module 135 converts the digital modulated voice signal into an analog modulated voice signal. To be noted, the control unit 17 can drive the voice modulating unit 13, which includes the A/D converting module 131, the processing module 133 and the D/A converting module 135, to generate the modulated voice signal.

In a step S05, the voice signal or the modulated voice signal is outputted. In this case, the communication unit 15 is to output the voice signal or the modulated voice signal to another telephone for establishing a communication. To be noted, the control unit 17 can decide a signal, such as the voice signal or the modulated voice signal, to be outputted by the communication unit 15.

In summary, the telephone for voice modulating provides a voice modulating unit for generating a modulated voice signal. The modulated voice signal is then outputted to another telephone. Thus, the user of the another telephone may not distinguish the identity of the speaker with the modulated voice. Accordingly, the telephone for voice modulating of the invention can provide some entertainment effects so as to improve the competitiveness thereof.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A telephone for voice modulating, comprising:
a receiver receiving a voice signal;
a voice modulating unit generating a modulated voice signal by modulating the voice signal;
a communication unit outputting a signal selected from a group consisting of the voice signal and the modulated voice signal; and
a control unit driving the voice modulating unit to generate the modulated voice signal and deciding the modulated voice signal outputted by the communication unit.

2. The telephone of claim 1, wherein the voice modulating unit comprises:
an A/D converting module converting the voice signal into a digital voice signal;
a processing module performing an operation of the digital voice signal to generate a digital modulated voice signal corresponding to the digital voice signal; and
a D/A converting module converting the digital modulated voice signal into the modulated voice signal and transmitting the modulated voice signal to the communication unit.

3. The telephone of claim 1, wherein the telephone is a mobile phone.

4. The telephone of claim 3, wherein the communication unit is a wireless communication module.

5. The telephone of claim 4, wherein the wireless communication module comprises an antenna for transmitting the modulated voice signal to another telephone.

6. The telephone of claim 1, wherein the telephone is a bounded telephone.

7. The telephone of claim 6, wherein the communication unit is a wired communication module.

8. The telephone of claim 1, wherein the receiver is a microphone.

9. A method for voice modulating, which is applied on a telephone, comprising:
receiving a voice signal;
modulating the voice signal to generate a modulated voice signal; and
outputting a signal selected from a group consisting of the voice signal and the modulated voice signal.

10. The method of claim 9, wherein the step of modulating the voice signal to generate the modulated voice signal comprises the following sub-steps of:
converting the voice signal into a digital voice signal;
performing an operation of the digital voice signal to generate a digital modulated voice signal by modulating the digital voice signal; and
converting the digital modulated voice signal into the modulated voice signal.

11. The method of claim 10, wherein the step of converting the voice signal into the digital voice signal comprises sampling and quantifying the voice signal.

12. The method of claim 10, wherein the step of performing the operation of the digital voice signal to generate the digital modulated voice signal comprises:
performing a Fourier Transform of the digital voice signal;
changing the frequency of the digital voice signal; and
performing an inverse Fourier Transform of the changed digital voice signal.

13. The method of claim 9, wherein the telephone is a mobile phone.

14. The method of claim 9, wherein the telephone is a bounded telephone.
